(19) United States
(12) Patent Application Publication
(10) Pub. No.: US 2025/0209515 A1
(43) Pub. Date: Jun. 26, 2025

(54) BATTERY REPLACEMENT

(71) Applicant: VOLVO TRUCK CORPORATION, Göteborg (SE)

(72) Inventor: Gurpreet SINGH, Västra Frölunda (SE)

(73) Assignee: VOLVO TRUCK CORPORATION, Göteborg (SE)

(21) Appl. No.: 18/982,162

(22) Filed: Dec. 16, 2024

(30) Foreign Application Priority Data
Dec. 20, 2023 (EP) 23218839.1

(51) Int. Cl. G06Q 30/0601

(52) U.S. Cl. CPC G06Q 30/0631

(57) ABSTRACT

A computer system comprising processing circuitry is presented. The processing circuitry is configured to obtain target battery historic usage data of an initial battery targeted for replacement and to obtain a plurality of candidate battery historic usage data. Each candidate battery historic usage data is associated with a specific replacement candidate battery. The processing circuitry is further configured to select a specific replacement candidate battery as a replacement battery for the initial battery based on a comparison of the target battery historic usage data to the candidate battery historic usage data.

### TECHNICAL FIELD

The disclosure relates generally to electrical power and batteries. In particular aspects, the disclosure relates to replacement of batteries. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Global electrification of vehicles increases demand for electrical storages such as batteries. To compensate for fluctuating electricity pricing and enable off-grid operation, domestic batteries are provided which further increase the demand for electrical storages.

Batteries have a limited lifetime and may eventually have to be replaced. Moreover, electrical vehicles may be damaged in accidents forcing them to be scrapped although their batteries may still be usable.

However, replacing a battery with a used battery is not something that is easily done. The replacement battery generally has to be of the same type and chemistry as the battery to be replaced in that mixing different battery types or chemistries may lead to performance issues and potential safety hazards. Even following these principles, there is room for improvement when it comes to utilizing used batteries as replacement batteries.

### SUMMARY

According to a first aspect of the disclosure, a computer system comprising processing circuitry is presented. The processing circuitry is configured to obtain target battery historic usage data of an initial battery targeted for replacement and to obtain a plurality of candidate battery historic usage data, each candidate battery historic usage data being associated with a specific replacement candidate battery. The processing circuitry is further configured to select a specific replacement candidate battery as a replacement battery for the initial battery based on a comparison of the target battery historic usage data to the candidate battery historic usage data. The first aspect of the disclosure may seek to simplify and enable the use of used batteries as replacement batteries in applications. A technical benefit may include reduced environmental impact as used batteries may be reused and a total lifespan of batteries may be increased. This is provided with a reduced risk of reducing performance of the application.

Optionally in some examples, including in at least one preferred example, the target battery historic usage data and the candidate battery historic usage data comprise cycling age data of associated batteries, the cycling age data comprising one or more of upper charging limit data, lower discharging limit data, depth of discharge data, peak current data, average current data, energy throughput data, capacity throughput data, temperature data and/or usage time data. A technical benefit may include accurate matching of candidate batteries with target batteries targeted for replacement.

Optionally in some examples, including in at least one preferred example, the target battery historic usage data and the candidate battery historic usage data comprise calendric age data of associated batteries, the calendric age data comprising one or more of storage charge level data, storage time data and/or storage temperature data. A technical benefit may include accurate matching of candidate batteries with target batteries targeted for replacement.

Optionally in some examples, including in at least one preferred example, the target battery historic usage data and the candidate battery historic usage data comprises mechanical age data of associated batteries, the mechanical age data comprising vibration data and/or shock data. A technical benefit may include accurate matching of candidate batteries with target batteries targeted for replacement.

Optionally in some examples, including in at least one preferred example, the comparison of the target battery historic usage data to the candidate battery historic usage data comprises: rating each replacement candidate battery by determining a similarity of the candidate battery historic usage data and the target battery historic usage data. A technical benefit may include accurate matching of candidate batteries with target batteries targeted for replacement.

Optionally in some examples, including in at least one preferred example, the target battery historic usage data and the candidate battery historic usage data each comprises a plurality of different usage data parameters, and determining a similarity of the candidate battery historic usage data and the target battery historic usage data comprises weighting the respective usage data parameters of the candidate battery historic usage data and the target battery historic usage data. A technical benefit may include accurate matching of candidate batteries with target batteries targeted for replacement.

Optionally in some examples, including in at least one preferred example, the processing circuitry is further configured to: obtain a state of health, SoH, of the initial battery; obtain a SoH of one or more of the specific replacement candidate batteries; and select a specific replacement candidate battery as the replacement battery further based on a comparison of the SoH of the initial battery to SoHs of the one or more of the specific replacement candidate batteries. A technical benefit may include accurate matching of candidate batteries with target batteries targeted for replacement.

Optionally in some examples, including in at least one preferred example, the target battery historic usage data and the candidate battery historic usage data comprise cycling age data of associated batteries, the cycling age data comprising one or more of upper charging limit data, lower discharging limit data, depth of discharge data, peak current data, average current data, energy throughput data, capacity throughput data, temperature data and/or usage time data; the target battery historic usage data and the candidate battery historic usage data comprise calendric age data of associated batteries, the calendric age data comprising one or more of storage charge level data, storage time data and/or storage temperature data; the target battery historic usage data and the candidate battery historic usage data comprises mechanical age data of associated batteries, the mechanical age data comprising vibration data and/or shock data; the comparison of the target battery historic usage data to the candidate battery historic usage data comprises: rating each replacement candidate battery by determining a similarity of the candidate battery historic usage data and the target battery historic usage data; the target battery historic usage data and the candidate battery historic usage data each comprises a plurality of different usage data parameters, and determining a similarity of the candidate battery historic usage data and the target battery historic usage data comprises weighting the respective usage data parameters of the candidate battery historic usage data and the target battery historic usage data; the processing circuitry is further configured to: obtain a state of health, SoH, of the initial battery; obtain a SoH of one or more of the specific replacement candidate batteries; and select a specific replacement candidate battery as the replacement battery further based on a comparison of the SoH of the initial battery to SoHs of the one or more of the specific replacement candidate batteries; and obtaining target battery historic usage data of the initial battery comprises: obtaining at least part of the target battery historic usage data from a non-volatile data storage of the initial battery and/or a cloud server. A technical benefit may include accurately matching of candidate batteries with target batteries targeted for replacement. A technical benefit may include accurate matching of candidate batteries with target batteries targeted for replacement and convenient obtaining of the target battery historic usage data.

According to a second aspect of the disclosure, an energy storage system is presented. The energy storage system comprises at least one battery and processing circuitry configured to store usage data of the at least one battery as target battery historic usage data for use as target battery historic usage data and/or candidate battery historic usage data by the computer system of the first aspect, preferably the energy storage system further comprises a non-volatile data storage configured to store the usage data. The second aspect of the disclosure may seek to simplify and enable the use of used batteries as replacement batteries in applications. A technical benefit may include reduced environmental impact as used batteries may be reused and a total lifespan of batteries may be increased. This is provided with a reduced risk of reducing performance of the application.

According to a third aspect of the disclosure, a vehicle comprising the energy storage system of the second aspect is presented. The third aspect of the disclosure may seek to simplify and enable the use of used batteries as replacement batteries in applications. A technical benefit may include reduced environmental impact as used batteries may be reused and a total lifespan of batteries may be increased. This is provided with a reduced risk of reducing performance of the application.

According to a fourth aspect of the disclosure, a computer-implemented method is presented. The method comprises obtaining, by processing circuitry of a computer system, target battery historic usage data of an initial battery targeted for replacement; obtaining, by processing circuitry of the computer system, a plurality of candidate battery historic usage data, each candidate battery historic usage data being associated with a specific replacement candidate battery; and selecting, by processing circuitry of the computer system, a specific replacement candidate battery as replacement battery for the initial battery based on comparing, by processing circuitry of the computer system, the target battery historic usage data to the candidate battery historic usage data. The fourth aspect of the disclosure may seek to simplify and enable the use of used batteries as replacement batteries in applications. A technical benefit may include reduced environmental impact as used batteries may be reused and a total lifespan of batteries may be increased. This is provided with a reduced risk of reducing performance of the application.

Optionally in some examples, including in at least one preferred example, comparing the target battery historic usage data to the candidate battery historic usage data comprises: rating, by processing circuitry of the computer system, each replacement candidate battery by determining, by processing circuitry of the computer system, a similarity of the candidate battery historic usage data and the target battery historic usage data. A technical benefit may include accurate matching of candidate batteries with target batteries targeted for replacement.

Optionally in some examples, including in at least one preferred example, the target battery historic usage data and the candidate battery historic usage data each comprises a plurality of different usage data parameters, and determining a similarity of the candidate battery historic usage data and the target battery historic usage data comprises: weighting, by processing circuitry of the computer system, the respective usage data parameters of the candidate battery historic usage data and the target battery historic usage data. A technical benefit may include accurate matching of candidate batteries with target batteries targeted for replacement.

According to a fifth aspect of the disclosure, a computer program product is presented. The computer program product comprises program code for performing, when executed by processing circuitry, the method of the fourth aspect. The fifth aspect of the disclosure may seek to simplify and enable the use of used batteries as replacement batteries in applications. A technical benefit may include reduced environmental impact as used batteries may be reused and a total lifespan of batteries may be increased. This is provided with a reduced risk of reducing performance of the application.

According to a sixth aspect of the disclosure, a non-transitory computer-readable storage medium is presented. The non-transitory computer-readable storage medium comprises instructions, which when executed by processing circuitry, cause the processing circuitry to perform the method of the fourth aspect. The sixth aspect of the disclosure may seek to simplify and enable the use of used batteries as replacement batteries in applications. A technical benefit may include reduced environmental impact as used batteries may be reused and a total lifespan of batteries may be increased. This is provided with a reduced risk of reducing performance of the application.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary schematic view of a vehicle according to an example.

FIG. 2 is an exemplary schematic view of a computer system according to an example.

FIG. 3 is an exemplary schematic view of a replacement battery selection manager according to an example.

FIG. 4 is an exemplary schematic view of a computer system according to an example.

FIG. 5 is an exemplary schematic view of a method according to an example.

FIG. 6 is an exemplary schematic view of a computer program product according to an example.

FIG. 7 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

As mentioned, replacing a battery is a complex task that may, if done incorrectly, decrease performance of the device powered by the battery. This is specifically the case when one battery of a group of batteries is to be replaced. Preferably, the replacing battery should, within reason, match the specifications of the other batteries in the group of batteries. If the specification of the replacing battery fails to reach the specification of the other batteries of the group of batteries, the performance of the group of batteries may decrease. Correspondingly, if the specification of the replacing battery exceeds the specification of the other batteries of the group of batteries, the performance of the replacing battery may decrease.

If all batteries are new, replacing one battery may be a simple task of ensuring that specified chemistry, voltage and capacity of the batteries match when replacing one of the batteries. However, if the batteries have been used for a period time, replacing one battery with a new battery would be wasteful of the new battery. Replacing one battery with a used battery would be a lottery as performance of a battery will change over time depending on use. The present invention will enable matching of batteries when replacing batteries, even if both the replaced battery and replacing battery are used batteries. By comparing usage data of batteries, it is possible to use batteries having similar usage history as replacement batteries enabling reuse of used batteries with decreased risk of reducing performance of a system in which the batteries operate.

For the present disclosure, battery will be used as a general term and may be interpreted to mean battery cell, battery cell or a battery system. In general, battery is to be interpreted as the smallest replaceable electrical energy source of an energy storage device. For instance, in a battery back comprising a plurality of battery cell, a battery cell may be replaced and in a battery system comprising a plurality of battery packs, a battery pack may be replaced.

The teaching of the present application will be exemplified primarily from a perspective of replacing batteries in vehicles. However, as indicated above, the teachings are applicable to replacing of batteries in any application. Although the batteries are preferably rechargeable batteries, the teachings are applicable also to non-rechargeable batteries.

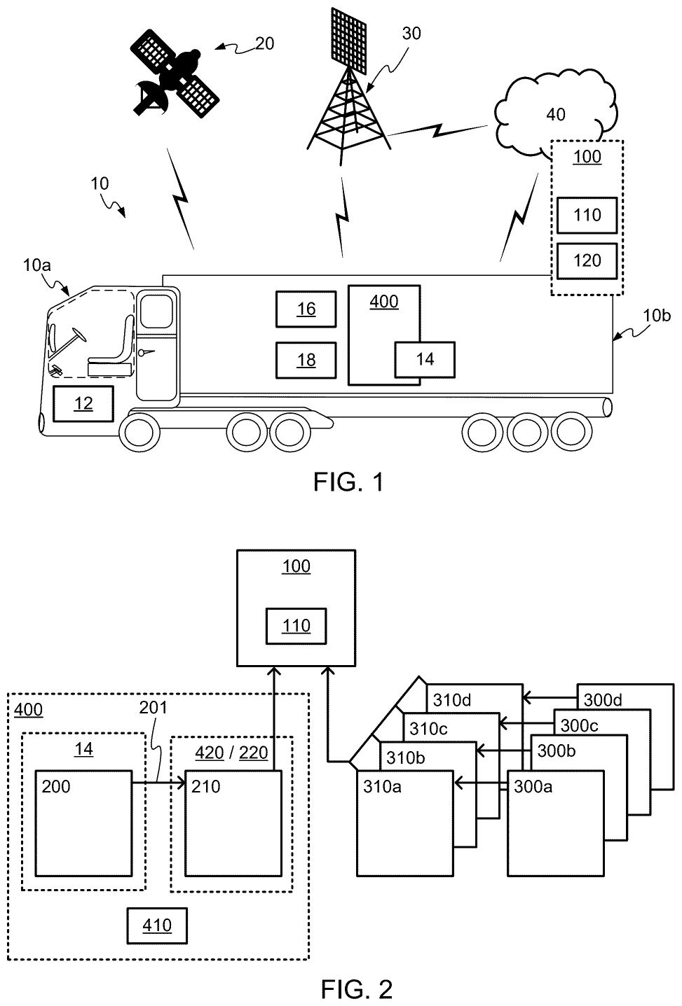

FIG. 1 is an exemplary schematic side view of a heavy-duty vehicle 10 (hereinafter referred to as vehicle 10). The vehicle 10 comprises a tractor unit 10a which is arranged to tow a trailer unit 10b. In other examples, other vehicles may be employed, e.g., trucks, buses, and construction equipment. The vehicle 10 comprises all vehicle units and associated functionality to operate as expected, such as a powertrain, chassis, and various control systems. The vehicle 10 comprises one or more propulsion sources 12. The propulsion source 12 may be any suitable propulsion source 12 exemplified by, but not limited to, one or more or a combination of an electrical motor, a combustion engine such as a diesel, gas or gasoline powered engine. The vehicle 10 further comprises an energy source 14 suitable for providing energy for the propulsion source 12. That is to say, if the propulsion source 12 is an electrical motor, a suitable energy source 14 would be a battery or a fuel cell. The vehicle 10 further comprises sensor circuitry 16 arranged to detect, measure, sense or otherwise obtain data relevant for operation of the vehicle 10. The sensor circuit 16 may comprise one or more of a voltmeter, a current meter, an accelerometer, a gyroscope, a wheel speed sensor, an ABS sensor, a throttle position sensor, a fuel level sensor, a temperature sensor, a pressure sensor, a rain sensor, a light sensor, proximity sensor, a lane departure warning sensor, a blind spot detection sensor, a TPMS sensor etc. Operational data relevant for operation of the vehicle 10 may include, but is not limited to, one or more of a speed of the vehicle 10, a weight of the vehicle 10, an inclination of the vehicle 10, a status of the energy source 14 of the vehicle 10 (state of charge, fuel level etc.), a current speed limit of a current road travelled by the vehicle 10, etc. The vehicle 10 may further comprise communications circuitry 18 configured to receive and/or send communication. The communications circuitry 18 may be configured to enable the vehicle 10 to communicate with one or more external devices or systems such as a cloud server 40. The communication with the external devices or systems may be directly or via a communications interface such as a cellular communications interface 30, such as a radio base station. The cloud server 40 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 18 may, additionally or alternatively, be configured to enable the vehicle 10 to be operatively connected to a Global Navigation Satellite System (GNSS) 20 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 20 to determine a geographical location of the vehicle 10.

In FIG. 1 a computer system 100 is shown. The vehicle 10 may comprise some or all parts of the computer system 100 and/or the cloud server 40 may comprise some or all part of the computer system 100. The computer system 100 may be operatively connected to the communications circuitry 18, the sensor circuitry 16, the energy source 14 and/or the propulsion source 12 of the vehicle 10. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100.

The vehicle 10 in FIG. 1 is an, at least partly, electrically powered vehicle and further comprise an energy storage system 400. The energy storage system 400 comprises at least one battery 14 that may form part of the energy source 14 of the vehicle 10.

In FIG. 2, a schematic view of the computer system 100 is shown. The computer system 100, or rather the processing circuitry 110 of the computer system 100, is configured to select a specific replacement candidate battery 300a, 300b, 300c, 300d to replace an initial battery 200 targeted for replacement. The computer system 100 is configured to select the specific replacement candidate battery 300 based on a comparison between target battery historic usage data 210 and candidate battery historic usage data 310a, 310b, 310c, 310d. Each candidate battery historic usage data 310a, 310b, 310c, 310d is associated with a respective specific replacement candidate battery 300a, 300b, 300c, 300d. The target battery historic usage data 210 and the candidate battery historic usage data 310a, 310b, 310c, 310d will be further explained in coming sections.

The target battery historic usage data 210 may be obtained in any suitable way. In FIG. 2, the initial battery 200 forms part of the energy storage system 400, and specifically of the energy source 14 of the vehicle 10. The initial battery 200 may be e.g. a battery pack of the energy storage system 400, or a battery cell of a battery pack. In the latter case, the following example may be isolated to a battery pack rather than an energy storage system 400. The energy storage system 400 comprise energy storage system processing circuitry 410 and optionally an energy storage system data storage 420. The energy storage system processing circuitry 410 may form part of the processing circuitry 110 of the computer system 100 and/or the energy storage system data storage 420 may form part of the storage device 120 of the computer system 100. The energy storage system processing circuitry 410 is configured to store, during use of the initial battery 200, i.e. prior to it being replaced, usage data 201 of the initial battery 200. The usage data 201 may be obtained by one or more suitable sensor circuitry 16 of the vehicle 10, or sensor circuitry of the initial battery 200 or the energy storage system 400. The usage data 201 may be stored at the energy storage system data storage 420 of the energy storage system 400, at a data storage 220 of the initial battery 200 and/or at the data storage 120 of the computer system 100. The data storage 120, 420 is preferably a non-volatile data storage such that the usage data 201 may be persistently stored even if e.g. power to the data storage 120, 420 is disrupted. The usage data 201 may be obtained by the computer system 100 as target battery historic usage data 210. The candidate battery historic usage data 310a, 310b, 310c, 310d may be provided correspondingly by storing usage data of the specific replacement candidate battery 300a, 300b, 300c, 300d.

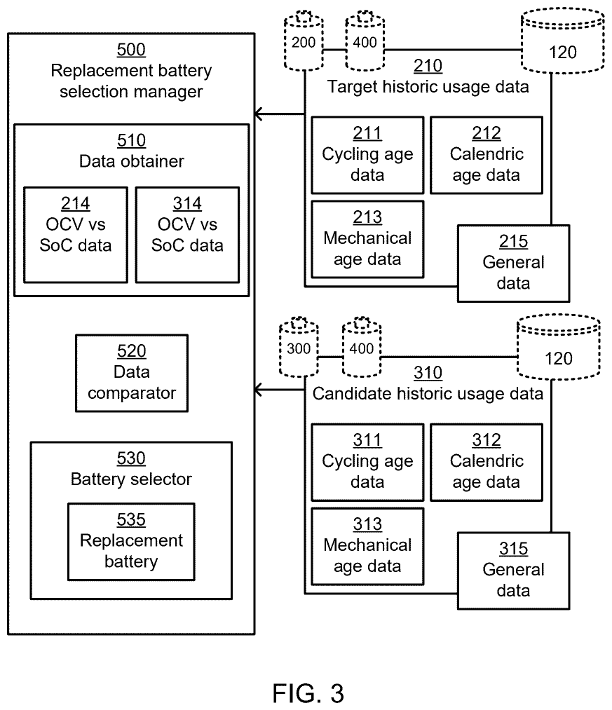

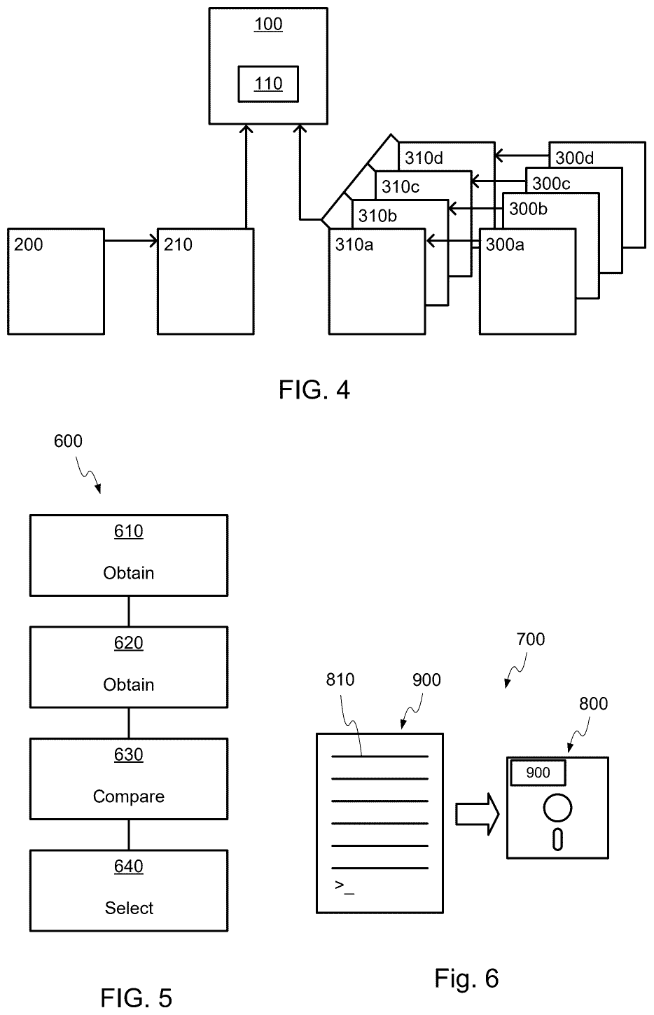

In FIG. 3, a schematic view of replacement battery selector 500 is shown. The processing circuitry 110 of the computer system 100 may be configured to cause or perform some or all features, functionalities and examples of the replacement battery selector 500. In some examples, energy storage system processing circuitry 410 may be configured to cause or perform some features, functionalities and examples of the replacement battery selector 500. The replacement battery selector 500 comprises a data obtainer 510, a data comparator 520 and a battery selector 530.

The data obtainer 510 is configured to obtain target battery historic usage data 210 of an initial battery 200 targeted for replacement and to obtain a plurality of candidate battery historic usage data 310. As previously mentioned, each candidate battery historic usage data 310 is associated with a specific replacement candidate battery 300. The target battery historic usage data 210 may be obtained from e.g. the initial battery 200 (a storage device of the initial battery 200), the storage device 120 or an energy storage system 400 in which the initial battery 200 has been operating. The candidate battery historic usage data 210 may be obtained from e.g. the candidate battery 300 (a storage device of the candidate battery 300), the storage device 120 or an energy storage system 400 wherein the candidate battery 300 has been operating.

In some examples, the target historic usage data 210 and candidate battery historic usage data 310 may comprise general target data 215, 315. The general target data 215, 315 may comprise general data such as, but not limited to, rated voltage, chemistry, a rated (i.e. factory specified, marked, etc.) capacity, physical dimension (rated size, weight, etc.), rated impedance, etc. The general target data 215, 315 may be provided stand-alone and is not necessarily part of the historic usage data 210, 310.

In some examples, the general target data 215, 315 may comprise a state of health (SoH) of the battery 200, 300. The SoH of a battery 200, 300 is a measure that indicates an overall condition and performance capability of the battery 200, 300 relative to an original or optimal state of the battery 200, 300. SoH is commonly used for assessing a remaining useful life and functionality of a battery 200, 300. SoH is often expressed as a percentage, where 100% represents an initial or ideal health of the battery 200, 300, and a lower percentage corresponds to a reduced health level of the battery 200, 300.

Depending on the type (e.g. chemistry) of the battery 200, 300, different historic usage data 210, 310 may be relevant. To exemplify, a Lithium-ion (Li-Ion) battery may age faster (e.g. loose capacity) if it is discharged and/or charged completely, a Nickel-Cadmium (NiCd) battery will age faster if it is not completely discharged and a Nickel-Metal-Hydrid (NiMh) battery will age faster if it is not fully charged. Consequently, the historic usage data 210, 310 provided may depend on the type of the battery 200, 300.

In one example, the initial battery 200 and the replacement candidate batteries 300 are Li-Ion batteries. Li-ion batteries undergo a natural aging process over time due to a combination of chemical, physical, and environmental factors. Each charge and discharge cycle contributes to the degradation of the battery 200, 300. Over time, the electrodes (anode and cathode) experience structural changes, leading to a gradual reduction in the battery's capacity. Even when not in use, Li-ion batteries undergo aging over time. This is referred to as calendar aging. The chemical reactions within the battery 200, 300 continue, leading to breakdown of electrode materials and a decrease in overall capacity. Exposure to high temperatures accelerates the aging process of Li-ion batteries. Elevated temperatures may cause faster chemical reactions, leading to increased degradation of the electrodes and a reduction in the battery's lifespan. Depth of discharge (DoD) indicate a depth to which a battery 200, 300 is discharged during each cycle and affects its lifespan. Deeper discharge cycles generally lead to faster degradation. Shallower discharge cycles and avoiding full discharges can help mitigate the impact of cycling on battery health. Operating a battery 200, 300 at high voltage levels or subjecting the battery 200, 300 to overcharging may accelerate aging. Elevated voltages may cause unwanted side reactions, leading to the formation of unstable compounds and degradation of the electrodes. Storing a Li-ion battery at high or low SoC for extended periods may contribute to aging. It is generally recommended to store Li-Ion batteries at moderate states of charge to minimize stress on the electrodes. Chemical changes in the electrolyte over time may impact the performance of the battery 200, 300. These changes may include the formation of solid electrolyte interface (SEI) layers, which can affect the flow of ions within the battery. Materials used in the electrodes may undergo physical and chemical changes with repeated charge and discharge cycles. This may result in the formation of cracks, loss of active material, and changes in the structure of the electrodes. As a Li-ion battery ages, a capacity of the battery 200, 300 gradually decreases, and an internal resistance of the battery 200, 300 may increase. This leads to reduced energy storage and power delivery capabilities. Manufacturers often provide guidelines for maximizing the lifespan of lithium-ion batteries, including recommendations for charging, discharging, and storage conditions.

The target historic usage data 210 may comprise any data that is relevant for providing a suitable replacement candidate battery 300a, 300b, 300c, 300d to the initial battery 200. Preferably, the candidate battery historic usage data 310 comprise data corresponding to the target historic usage data 210 and the historic usage data 210, 310 will not be explained individually for each of the target historic usage data 210 and the candidate battery historic usage data 310. The historic usage data 210, 310 may comprise different usage data parameters 211, 311, 212, 312, 213, 313 that may be exemplified by, but not limited to, cyclic age data 211, 311 calendric age data 212, 312 and/or mechanical age data 213, 313.

The cycling age data 211, 311 comprise historic data of how the associated initial battery 200 or replacement candidate battery 300 has been cycled. The cycling age data 211, 311 may be exemplified, but not limited to, one or more of upper charging limit data, lower discharging limit data, depth of discharge data, peak current data, average current data, energy throughput data, capacity throughput data, temperature data and/or usage time data. The charging limit data may describe to what state of charge (SoC) or other suitable metric the battery 200, 300 has been charged/discharged. The charging/discharging limit data may indicate the maximum and/or minimum SoC the battery 200, 300 has been charged/discharged to. In some examples, the charging limit data may indicate a number of times the battery 200, 300 has been charged/discharged to the charging limit. Additionally, or alternatively, the cycling data 211, 311 may indicate a distribution (number of times, duration etc.) the battery 200, 300 has been at specific SoCs. Additionally, or alternatively, the cycling age data 211 may indicate currents drained and/or provided to the battery 200, 300. In some examples, the current may be provided as a histogram (or similar data set) indicating number of times, and/or a duration a specific current has been drained and/or provided to the battery 200, 300. In some examples, the cycling age data 211 may comprise peak and/or average current data indicating one or more of peak/average plugged in charging current data, peak/average regenerative charging current data and/or peak/average drainage current data. Additionally, or alternatively, the cycling data 211, 311 may indicate temperatures of the battery 200, 300, i.e. an ambient (and/or internal) temperature of the battery 200, 300 during use. As with the currents, the temperature may be specified as minimum, maximum and/or average temperature during use and may be provided as a histogram (or similar data set) indicating number of times, and/or a duration a specific temperature has been experienced by the battery 200, 300.

The calendric age data 212, 312 may comprise information of how old (in time) the battery 200, 300 is. The calendric age data 212, 312 may indicate a date of manufacture, a date of first use, a date or retirement etc. Additionally, or alternatively, the calendric age data 212, 312 may indicate a SOC of the battery 200, 300 during storage (before first use) and/or during retirement (after retirement). Additionally, or alternatively, the calendric age data 212, 312 may indicate a storage temperature of the battery 200, 300, i.e. an ambient (and/or internal) temperature of the battery 200, 300 during storage.

The mechanical age data mechanical age data 213, 313 indicates one or more parameters relevant for estimating a mechanical age of the battery 200, 300. In some examples, the mechanical age data 213, 313 indicates vibrations experienced by the battery 200, 300. In some examples, the vibrations may be categorized with regards to e.g. frequency, amplitude etc. Additionally, or alternatively, the mechanical age data 213, 313 may comprise humidity data indicating a humidity (max, min, average, etc.) experienced by the battery 200, 300.

In some examples, the data obtainer 510 may be configured to obtain open cell voltage, OCV, in relation to SOC data 214, 314 of the initial battery 200 and the specific replacement candidate battery 300. The OCV in relation to SOC data 214, 314 may in some examples be obtained correspondingly to the historic usage data 210, 310. In some examples, the OCV in relation to SOC data 214, 314 may be obtained by measuring, sensing or otherwise obtaining OCV data for different SOCs for the initial battery 200 and the specific replacement candidate battery 300.

The data comparator 520 of the replacement battery selection manager 500 is configured to compare the target battery historic usage data 210 to the candidate battery historic usage data 310. The comparison may be a data-point to data-point comparison between the target battery historic usage data 210 and the candidate battery historic usage data 310. To exemplify, data indicative cycling age data 211 of the target battery historic usage data 210 is compared to corresponding cycling age data 311 of the candidate battery historic usage data 310. The data comparator 520 may be configured to process the target battery historic usage data 210 and the candidate battery historic usage data 310 prior to the comparison and/or process a result of the comparison. To exemplify, the target battery historic usage data 210 and the candidate battery historic usage data 310 may be processed by averaging sampled data and/or detecting peak or minimum values prior to the comparison. The processing may be provided in addition to the data-point to data-point comparison in order to provide further data-points for comparison.

In some examples, wherein the OCV in relation to SOC data 214, 314 is provided, the data comparator 520 may compare the OCV in relation to SOC data 214 of the initial battery 200 to the OCV in relation to SOC data 314 of the replacement candidate batteries 300.

In some examples, the data comparator 520 is configured to rate each replacement candidate battery 300 based on a similarity between the target battery historic usage data 210 and the candidate battery historic usage data 310. The rating may comprise weighting the similarities between different candidate battery historic usage data 310 and their corresponding target battery historic usage data 210. The weighing may be provided based on an importance of the respective historic usage data 210, 310. To exemplify, cyclic age data 211, 311 may be considered more important than mechanical age data 213, 313 and similarities in cyclic age data 211, 311 are given a greater weight when rating the replacement candidate batteries 300.

The battery selector 530 is configured to select one of the replacement candidate batteries 300 as a replacement battery 535 to the initial battery 200. The battery selector 530 is configured to select the replacement battery 535 based on the comparison by the data comparator 520.

In a non-limiting specific example, a replacement battery 535 may be selected by obtaining historic usage data 210, 310 of both the initial battery 200 and a plurality of candidate replacement batteries 300. Tag all relevant historic usage data 210, 310 parameters on a scale from 1 to 10, where 1 belongs to mild regions of the parameter and 10 belongs to strong utilization regions of the parameter. To exemplify further, for a specific chemistry and battery design, a strong degradation may occur if the SoC of the batteries 200, 300 is in a region between 95 and 100%. However for another chemistry a corresponding region may be between 90 and 100%. To this end, as indicated above, importance and definition of pockets (i.e. bins of a histogram) to some degradation parameters are highly dependent on the battery chemistry and design. The historic usage data 210, 310 is weighted and a comparison between usage patterns of the batteries 200, 300 is determined. If the usage patterns of any two batteries 200, 300 match sufficiently, then the matching candidate replacement battery 300 may be considered as the replacement battery 535. If usage patterns do not match (even if SoH values match), the candidate replacement battery 300 is not considered as the replacement battery 535.

By enabling the teachings of the present disclosure, damaged batteries of a system may be replaced by used batteries without significantly affecting performance of other batteries in the system. This is environmentally sound as life-expectancy of the batteries of the system increases (less wear) and old used batteries may be given a second life in the system rather than being scrap.

With reference to FIG. 5, a computer system 100 comprising processing circuitry 110 is presented. The processing circuitry 110 is configured to obtain target battery historic usage data 210 of an initial battery 200 targeted for replacement and to obtain a plurality of candidate battery historic usage data 310a, 310b, 310c, 310d. Each candidate battery historic usage data 310a, 310b, 310c, 310d is associated with a specific replacement candidate battery 300a, 300b, 300c, 300d. The processing circuitry 110 is further configured to select a specific replacement candidate battery 300a, 300b, 300c, 300d as a replacement battery for the initial battery 200 based on a comparison of the target battery historic usage data 210 to the candidate battery historic usage data 310a, 310b, 310c, 310d.

With reference to FIG. 5, a block diagram of a method 600 is shown. The method 600 may be a computer implemented method 600. The processing circuitry 110 of the computer system 100 may be configured to cause, and/or perform the method 600 in part or in full. In some examples, the processing circuitry 410 of the energy storage system 400 may be configured to cause, and/or perform the method 600 in part or in full.

The method 600 comprises obtaining 610 target battery historic usage data 210 of the initial battery 200 targeted for replacement. The method further comprises obtaining 620 a plurality of candidate battery historic usage data 310. Each candidate battery historic usage data 310 is associated with a specific replacement candidate battery 300. The obtaining 610, 620 may be provided in suitable manner such as exemplified by the data obtainer 510 referenced in FIG. 3. The method 600 further comprises comparing 630 the target battery historic usage data 210 to the candidate battery historic usage data 310. The comparing 630 may be provided in suitable manner such as exemplified by the data comparator 520 referenced in FIG. 3. The method 600 further comprises selecting 640 a specific replacement candidate battery 300 as replacement battery 535 for the initial battery 200 based on the comparing 630. The selecting 640 may be provided in suitable manner such as exemplified by the data selector 530 referenced in FIG. 3.

The method 600 introduced in FIG. 5 may be changed, expanded or otherwise altered to comprise any feature presented in the present disclosure and/or to provide any effect presented in the present disclosure.

In FIG. 6 a computer program product 700 is shown. The computer program product 700 comprises a computer program 900 and a non-transitory computer readable medium 800. The computer program 900 may be stored on the computer readable medium 800. The computer readable medium 800 is, in FIG. 6, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 900 comprises instruction 910 e.g. program instruction, software code, that, when executed by processing circuitry cause the processing circuitry to perform the method 600 introduced with reference to FIG. 5.

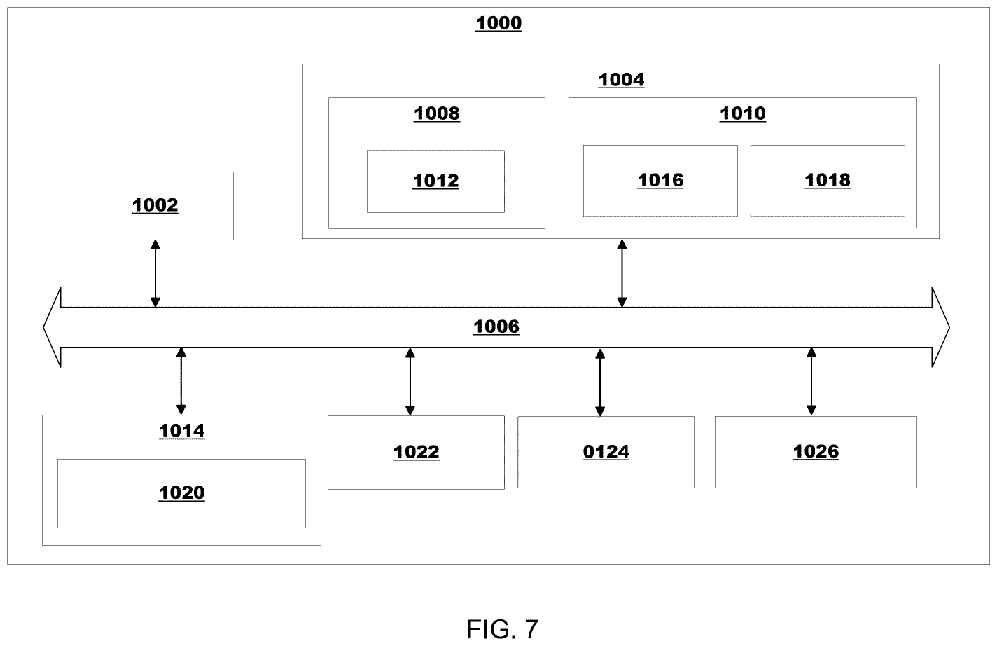

FIG. 7 is a schematic diagram of a computer system 1000 for implementing examples disclosed herein. The computer system 1000 may be the computer system 100 introduced in reference to FIG. 1. The computer system 1000 is adapted to execute instructions from a computer-readable medium to perform these and/or any of the functions or processing described herein. The computer system 1000 may be connected (e.g., networked) to other machines in a LAN (Local Area Network), LIN (Local Interconnect

Network), automotive network communication protocol (e.g., FlexRay), an intranet, an extranet, or the Internet. While only a single device is illustrated, the computer system 1000 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 1000 may comprise at least one computing device or electronic device capable of including firmware, hardware, and/or executing software instructions to implement the functionality described herein. The computer system 1000 may include processing circuitry 1002 (e.g., processing circuitry including one or more processor devices or control units), a memory 1004, and a system bus 1006. The processing circuitry 1002 may be the processing circuitry 110 of the computer system 100 of FIG. 1. The computer system 1000 may include at least one computing device having the processing circuitry 1002. The system bus 1006 provides an interface for system components including, but not limited to, the memory 1004 and the processing circuitry 1002. The processing circuitry 1002 may include any number of hardware components for conducting data or signal processing or for executing computer code stored in memory 1004. The processing circuitry 1002 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 1002 may further include computer executable code that controls operation of the programmable device.

The system bus 1006 may be any of several types of bus structures that may further interconnect to a memory bus (with or without a memory controller), a peripheral bus, and/or a local bus using any of a variety of bus architectures. The memory 1004 may be one or more devices for storing data and/or computer code for completing or facilitating methods described herein. The memory 1004 may include database components, object code components, script components, or other types of information structure for supporting the various activities herein. Any distributed or local memory device may be utilized with the systems and methods of this description. The memory 1004 may be communicably connected to the processing circuitry 1002 (e.g., via a circuit or any other wired, wireless, or network connection) and may include computer code for executing one or more processes described herein. The memory 1004 may include non-volatile memory 1008 (e.g., read-only memory (ROM), erasable programmable read-only memory (EPROM), electrically erasable programmable read-only memory (EEPROM), etc.), and volatile memory 1010 (e.g., random-access memory (RAM)), or any other medium which can be used to carry or store desired program code in the form of machine-executable instructions or data structures and which can be accessed by a computer or other machine with processing circuitry 1002. A basic input/output system (BIOS) 1012 may be stored in the non-volatile memory 1008 and can include the basic routines that help to transfer information between elements within the computer system 1000.

The computer system 1000 may further include or be coupled to a non-transitory computer-readable storage medium such as the storage device 1014, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1014 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 1014 and/or in the volatile memory 1010, which may include an operating system 1016 and/or one or more program modules 1018. All or a portion of the examples disclosed herein may be implemented as a computer program 1020 stored on a transitory or non-transitory computer-usable or computer-readable storage medium (e.g., single medium or multiple media), such as the storage device 1014, which includes complex programming instructions (e.g., complex computer-readable program code) to cause the processing circuitry 1002 to carry out actions described herein. Thus, the computer-readable program code of the computer program 1020 can comprise software instructions for implementing the functionality of the examples described herein when executed by the processing circuitry 1002. In some examples, the storage device 1014 may be a computer program product (e.g., readable storage medium) storing the computer program 1020 thereon, where at least a portion of a computer program 1020 may be loadable (e.g., into a processor) for implementing the functionality of the examples described herein when executed by the processing circuitry 1002. The processing circuitry 1002 may serve as a controller or control system for the computer system 1000 that is to implement the functionality described herein.

The computer system 1000 may include an input device interface 1022 configured to receive input and selections to be communicated to the computer system 1000 when executing instructions, such as from a keyboard, mouse, touch-sensitive surface, etc. Such input devices may be connected to the processing circuitry 1002 through the input device interface 1022 coupled to the system bus 1006 but can be connected through other interfaces, such as a parallel port, an Institute of Electrical and Electronic Engineers (IEEE) 1394 serial port, a Universal Serial Bus (USB) port, an IR interface, and the like. The computer system 1000 may include an output device interface 1024 configured to forward output, such as to a display, a video display unit (e.g., a liquid crystal display (LCD) or a cathode ray tube (CRT)). The computer system 1000 may include a communications interface 1026 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1. A computer system 100 comprising processing circuitry 110 configured to: obtain target battery historic usage data 210 of an initial battery 200 targeted for replacement; obtain a plurality of candidate battery historic usage data 310, each candidate battery historic usage data 310 being associated with a specific replacement candidate battery 300; and select a specific replacement candidate battery 300 as a replacement battery 535 for the initial battery 200 based on a comparison of the target battery historic usage data 210 to the candidate battery historic usage data 310.

Example 2. The computer system 100 of example 1, wherein the target battery historic usage data 210 and the candidate battery historic usage data 310 comprise cycling age data 211, 311 of associated batteries 200, 300, the cycling age data 211, 311 comprising one or more of upper charging limit data, lower discharging limit data, depth of discharge data, peak current data, average current data, energy throughput data, capacity throughput data, temperature data and/or usage time data.

Example 3. The computer system 100 of example 2, wherein the cycling age data 211, 311 comprises peak current data, wherein the peak current data indicate one or more of peak plugged in charging current data, peak regenerative charging current data and/or peak drainage current data.

Example 4. The computer system 100 of example 2 or 3, wherein the cycling age data 211, 311 comprises average current data, wherein the average current data indicate one or more of average plugged in charging current data, average regenerative charging current data and/or average drainage current data.

Example 5. The computer system 100 of any one of examples 1 to 4, wherein the target battery historic usage data 210 and the candidate battery historic usage data 310 comprise calendric age data 212, 312 of associated batteries 200, 300, the calendric age data 212, 312 comprising one or more of storage charge level data, storage time data and/or storage temperature data.

Example 6. The computer system 100 of any one of examples 1 to 5, wherein the target battery historic usage data 210 and the candidate battery historic usage data 310 comprises mechanical age data 213, 313 of associated batteries 200, 300, the mechanical age data comprising vibration data and/or shock data.

Example 7. The computer system 100 of any one of examples 1 to 6, wherein the comparison of the target battery historic usage data 210 to the candidate battery historic usage data 310 comprises: rating each replacement candidate battery 300 by determining a similarity of the candidate battery historic usage data 310 and the target battery historic usage data 210.

Example 8. The computer system 100 of any one of examples 1 to 7, wherein the target battery historic usage data 210 and the candidate battery historic usage data 310 each comprises a plurality of different usage data parameters 211, 212, 213, 214, 215, 311, 312, 313, 314, 315, and determining a similarity of the candidate battery historic usage data 310 and the target battery historic usage data 210 comprises weighting the respective usage data parameters 211, 212, 213, 214, 215, 311, 312, 313, 314, 315 of the candidate battery historic usage data 310 and the target battery historic usage data 210.

Example 9. The computer system 100 of any one of examples 1 to 8, wherein obtaining target battery historic usage data 210 of the initial battery 200 comprises: obtaining at least part of the target battery historic usage data 210 from a non-volatile data storage 220 of the initial battery 200.

Example 10. The computer system 100 of any one of examples 1 to 9, wherein obtaining target battery historic usage data 210 of the initial battery 200 comprises: obtaining at least part of the target battery historic usage data 210 from a server system 40.

Example 11. The computer system 100 of any one of examples 1 to 10, wherein the processing circuitry 110 is further configured to: obtain a state of health, SoH, of the initial battery 200; obtain a SoH of one or more of the specific replacement candidate batteries 300; and select a specific replacement candidate battery 300 as the replacement battery 535 further based on a comparison of the SoH of the initial battery 200 to SoHs of the one or more of the specific replacement candidate batteries 300.

Example 12. The computer system 100 of examples 1 to 11, wherein the processing circuitry 110 is further configured to: obtain open cell voltage, OCV, in relation to state of charge, SOC, data 214 of the initial battery 200; obtain OCV in relation to SOC data 314 one or more of the specific replacement candidate batteries 300; and select a specific replacement candidate battery 300 as replacement battery 535 further based on the OCV in relation to SOC data 214 of the initial battery 200, to OCV in relation to SOC data 314 of the one or more of the specific replacement candidate batteries 300.

Example 13. The computer system 100 of example 1, wherein the target battery historic usage data 210 and the candidate battery historic usage data 310 comprise cycling age data 211, 311 of associated batteries 200, 300, the cycling age data 211, 311 comprising one or more of upper charging limit data, lower discharging limit data, depth of discharge data, peak current data, average current data, energy throughput data, capacity throughput data, temperature data and/or usage time data; wherein the cycling age data 211, 311 comprises peak current data, wherein the peak current data indicate one or more of peak plugged in charging current data, peak regenerative charging current data and/or peak drainage current data; wherein the cycling age data 211, 311 comprises average current data, wherein the average current data indicate one or more of average plugged in charging current data, average regenerative charging current data and/or average drainage current data; wherein the target battery historic usage data 210 and the candidate battery historic usage data 310 comprise calendric age data 212, 312 of associated batteries 200, 300, the calendric age data 212, 312 comprising one or more of storage charge level data, storage time data and/or storage temperature data; wherein the target battery historic usage data 210 and the candidate battery historic usage data 310 comprises mechanical age data 213, 313 of associated batteries 200, 300, the mechanical age data comprising vibration data and/or shock data; wherein the comparison of the target battery historic usage data 210 to the candidate battery historic usage data 310 comprises: rating each replacement candidate battery 300 by determining a similarity of the candidate battery historic usage data 310 and the target battery historic usage data 210; wherein the target battery historic usage data 210 and the candidate battery historic usage data 310 each comprises a plurality of different usage data parameters 211, 212, 213, 214, 215, 311, 312, 313, 314, 315, and determining a similarity of the candidate battery historic usage data 310 and the target battery historic usage data 210 comprises weighting the respective usage data parameters 211, 212, 213, 214, 215, 311, 312, 313, 314, 315 of the candidate battery historic usage data 310 and the target battery historic usage data 210; wherein obtaining target battery historic usage data 210 of the initial battery 200 comprises: obtaining at least part of the target battery historic usage data 210 from a non-volatile data storage 220 of the initial battery 200; wherein obtaining target battery historic usage data 210 of the initial battery 200 comprises: obtaining at least part of the target battery historic usage data 210 from a server system 40; wherein the processing circuitry 110 is further configured to: obtain a state of health, SoH, of the initial battery 200; obtain a SoH of one or more of the specific replacement candidate batteries 300; and select a specific replacement candidate battery 300 as the replacement battery 535 further based on a comparison of the SoH of the initial battery 200 to SoHs of the one or more of the specific replacement candidate batteries 300; wherein the processing circuitry 110 is further configured to: obtain open cell voltage, OCV, in relation to state of charge, SOC, data 214 of the initial battery 200; obtain OCV in relation to SOC data 314 one or more of the specific replacement candidate batteries 300; and select a specific replacement candidate battery 300 as replacement battery 535 further based on the OCV in relation to SOC data 214 of the initial battery 200, to OCV in relation to SOC data 314 of the one or more of the specific replacement candidate batteries 300.

Example 14. An energy storage system 400 comprising at least one battery 200 and processing circuitry 410 configured to store usage data 201 of the at least one battery 200 as target battery historic usage data 210 for use as target battery historic usage data 210 and/or candidate battery historic usage data 310 by the computer system 100 of any one of examples 1 to 13.

Example 15. The energy storage system 400 of example 14 further comprising a non-volatile data storage 420 configured to store the usage data 201.

Example 16. A vehicle 10 comprising the energy storage system 400 of example 14 or 15.

Example 17. The vehicle 10 of example 16, wherein the vehicle 10 is a heavy-duty vehicle.

Example 18. A computer-implemented method 600, comprising: obtaining 610, by processing circuitry 110 of a computer system 100, target battery historic usage data 210 of an initial battery 200 targeted for replacement; obtaining 620, by processing circuitry 110 of the computer system 100, a plurality of candidate battery historic usage data 310, each candidate battery historic usage data 310 being associated with a specific replacement candidate battery 300; and selecting 640, by processing circuitry 110 of the computer system 100, a specific replacement candidate battery 300 as replacement battery 535 for the initial battery 200 based on comparing 630, by processing circuitry 110 of the computer system 100, the target battery historic usage data 210 to the candidate battery historic usage data 310.

Example 19. The computer implemented method 600 of example 18, wherein comparing 630 the target battery historic usage data 210 to the candidate battery historic usage data 310 comprises: rating, by processing circuitry 110 of the computer system 100, each replacement candidate battery 300 by determining, by processing circuitry 110 of the computer system 100, a similarity of the candidate battery historic usage data 310 and the target battery historic usage data 210.

Example 20. The computer implemented method 600 of example 19, wherein the target battery historic usage data 210 and the candidate battery historic usage data 310 each comprises a plurality of different usage data parameters 211, 212, 213, 214, 215, 311, 312, 313, 314, 315, and determining a similarity of the candidate battery historic usage data 310 and the target battery historic usage data 210 comprises: weighting, by processing circuitry 110 of the computer system 100, the respective usage data parameters 211, 212, 213, 214, 215, 311, 312, 313, 314, 315 of the candidate battery historic usage data 310 and the target battery historic usage data 210.

Example 21. The computer implemented method 600 of any one of examples 18 to 20, further comprising: obtaining, by processing circuitry 110 of the computer system 100, a state of health, SoH, of the initial battery 200; obtaining, by processing circuitry 110 of the computer system 100, a SoH of one or more of the replacement candidate batteries; and selecting, by processing circuitry 110 of the computer system 100, a specific replacement candidate battery 300 as replacement battery 535 further based on a comparison of the SoH of the initial battery 200 to SoHs of the one or more of the specific replacement candidate batteries 300.

Example 22. A computer program product 700 comprising program code 810 for performing, when executed by processing circuitry 110, the method 600 of any of examples 18 to 21.

Example 23. A non-transitory computer-readable storage medium 800 comprising instructions 810, which when executed by processing circuitry 110, cause the processing circuitry 110 to perform the method of any of examples 18 to 21.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain target battery historic usage data of an initial battery targeted for replacement;
obtain a plurality of candidate battery historic usage data, each candidate battery historic usage data being associated with a specific replacement candidate battery; and
select a specific replacement candidate battery as a replacement battery for the initial battery based on a comparison of the target battery historic usage data to the candidate battery historic usage data.

2. The computer system of claim 1, wherein the target battery historic usage data and the candidate battery historic usage data comprise cycling age data of associated batteries, the cycling age data comprising one or more of upper charging limit data, lower discharging limit data, depth of discharge data, peak current data, average current data, energy throughput data, capacity throughput data, temperature data and/or usage time data.

3. The computer system of claim 2, wherein the cycling age data comprises peak current data, wherein the peak current data indicate one or more of peak plugged in charging current data, peak regenerative charging current data and/or peak drainage current data.

4. The computer system of claim 2, wherein the cycling age data comprises average current data, wherein the average current data indicate one or more of average plugged in charging current data, average regenerative charging current data and/or average drainage current data.

5. The computer system of claim 1, wherein the target battery historic usage data and the candidate battery historic usage data comprise calendric age data of associated batteries, the calendric age data comprising one or more of storage charge level data, storage time data and/or storage temperature data.

6. The computer system of claim 1, wherein the target battery historic usage data and the candidate battery historic usage data comprises mechanical age data of associated batteries, the mechanical age data comprising vibration data and/or shock data.

7. The computer system of claim 1, wherein the comparison of the target battery historic usage data to the candidate battery historic usage data comprises:
rating each replacement candidate battery by determining a similarity of the candidate battery historic usage data and the target battery historic usage data.

8. The computer system of claim 1, wherein the target battery historic usage data and the candidate battery historic usage data each comprises a plurality of different usage data parameters, and determining a similarity of the candidate battery historic usage data and the target battery historic usage data comprises weighting the respective usage data parameters of the candidate battery historic usage data and the target battery historic usage data.

9. The computer system of claim 1, wherein obtaining target battery historic usage data of the initial battery comprises: obtaining at least part of the target battery historic usage data from a non-volatile data storage of the initial battery.

10. The computer system of claim 1, wherein obtaining target battery historic usage data of the initial battery comprises: obtaining at least part of the target battery historic usage data from a server system.

11. The computer system of claim 1, wherein the processing circuitry is further configured to:
obtain a state of health, SoH, of the initial battery;
obtain a SoH of one or more of the specific replacement candidate batteries; and
select a specific replacement candidate battery as the replacement battery further based on a comparison of the SoH of the initial battery to SoHs of the one or more of the specific replacement candidate batteries.

12. The computer system of claim 1, wherein the processing circuitry is further configured to: obtain open cell voltage, OCV, in relation to state of charge, SOC, data of the initial battery; obtain OCV in relation to SOC data one or more of the specific replacement candidate batteries; and select a specific replacement candidate battery as replacement battery further based on the OCV in relation to SOC data of the initial battery, to OCV in relation to SOC data of the one or more of the specific replacement candidate batteries.

13. The computer system of claim 1, wherein the target battery historic usage data and the candidate battery historic usage data comprise cycling age data of associated batteries, the cycling age data comprising one or more of upper charging limit data, lower discharging limit data, depth of discharge data, peak current data, average current data, energy throughput data, capacity throughput data, temperature data and/or usage time data; wherein the target battery historic usage data and the candidate battery historic usage data comprise calendric age data of associated batteries, the calendric age data comprising one or more of storage charge level data, storage time data and/or storage temperature data; wherein the target battery historic usage data and the candidate battery historic usage data comprises mechanical age data of associated batteries, the mechanical age data comprising vibration data and/or shock data; wherein the comparison of the target battery historic usage data to the candidate battery historic usage data comprises: rating each replacement candidate battery by determining a similarity of the candidate battery historic usage data and the target battery historic usage data; wherein the target battery historic usage data and the candidate battery historic usage data each comprises a plurality of different usage data parameters, and determining a similarity of the candidate battery historic usage data (310) and the target battery historic usage data comprises weighting the respective usage data parameters of the candidate battery historic usage data and the target battery historic usage data; wherein the processing circuitry is further configured to: obtain a state of health, SoH, of the initial battery; obtain a SoH of one or more of the specific replacement candidate batteries; and select a specific replacement candidate battery as the replacement battery further based on a comparison of the SoH of the initial battery to SoHs of the one or more of the specific replacement candidate batteries; and wherein obtaining target battery historic usage data of the initial battery comprises: obtaining at least part of the target battery historic usage data from a non-volatile data storage of the initial battery and/or a cloud server.

14. An energy storage system comprising at least one battery and processing circuitry configured to store usage data of the at least one battery as target battery historic usage data for use as target battery historic usage data and/or candidate battery historic usage data by the computer system of claim 1, preferably the energy storage system further comprises a non-volatile data storage configured to store the usage data.

15. A vehicle comprising the energy storage system of claim 14.

16. A computer-implemented method, comprising:
obtaining, by processing circuitry of a computer system, target battery historic usage data of an initial battery targeted for replacement;
obtaining, by processing circuitry of the computer system, a plurality of candidate battery historic usage data, each candidate battery historic usage data being associated with a specific replacement candidate battery; and
selecting, by processing circuitry of the computer system, a specific replacement candidate battery as replacement battery for the initial battery based on comparing, by processing circuitry of the computer system, the target battery historic usage data to the candidate battery historic usage data.

17. The computer implemented method of claim 16, wherein comparing the target battery historic usage data to the candidate battery historic usage data comprises:
rating, by processing circuitry of the computer system, each replacement candidate battery by determining, by processing circuitry of the computer system, a similarity of the candidate battery historic usage data and the target battery historic usage data.

18. The computer implemented method of claim 16, wherein the target battery historic usage data and the candidate battery historic usage data each comprises a plurality of different usage data parameters, and determining a similarity of the candidate battery historic usage data and the target battery historic usage data comprises:
weighting, by processing circuitry of the computer system, the respective usage data parameters of the candidate battery historic usage data and the target battery historic usage data.

19. A computer program product comprising program code for performing, when executed by processing circuitry, the method of claim 16.

20. A non-transitory computer-readable storage medium comprising instructions, which when executed by processing circuitry, cause the processing circuitry to perform the method of claim 16.
